(19) United States
(12) Patent Application Publication
(10) Pub. No.: US 2017/0335781 A1
(43) Pub. Date: Nov. 23, 2017

(54) CARBON MONOXIDE DETECTION SYSTEM FOR A MOTOR VEHICLE

(71) Applicant: FORD GLOBAL TECHNOLOGIES, LLC, Dearborn, MI (US)

(72) Inventor: Andrew John Augusty, Royal Oak, MI (US)

(21) Appl. No.: 15/160,797

(22) Filed: May 20, 2016

(51) Int. Cl. F02D 41/22; F02D 41/04; G08B 21/14; F02D 41/26; B60R 11/00

(52) U.S. Cl. CPC F02D 41/22; G08B 21/14; F02D 41/26; F02D 41/042; B60R 2011/0003

(57) ABSTRACT

A carbon monoxide detection system is provided for a motor vehicle. That carbon monoxide detection system includes a carbon monoxide detector, a battery-free power circuit for powering the carbon monoxide detector and a control module. The control module is configured to stop an internal combustion engine of the motor vehicle when a concentration of carbon monoxide detected by the carbon monoxide detector over a set period of time exceeds a predetermined level.

### TECHNICAL FIELD

This document relates generally to the motor vehicle equipment field and, more particularly, to a carbon monoxide detection system for protecting motor vehicle occupants from potential harm caused by high levels of carbon monoxide in the environment.

### BACKGROUND

There have been times when a motor vehicle operator chooses to warm up the motor vehicle while parked in the garage. At other times the motor vehicle operator simply forgets to turn off the motor vehicle after entering the garage and then the home. In an enclosed, non-ventilated environment such as a garage, vehicle fumes, including potentially dangerous carbon monoxide, may reach high levels capable of causing bodily harm and even death. Such fumes may penetrate from the garage area into a home. Thus, it is an important safety consideration to monitor the levels of carbon monoxide in the environment and stop the operation of the internal combustion engine of a motor vehicle when those levels reach or exceed a predetermined level.

This document relates to a new and improved carbon monoxide detection system for this very purpose.

### SUMMARY

In accordance with the purposes and benefits described herein, a carbon monoxide detection system is provided for a motor vehicle. That carbon monoxide detection system comprises a carbon monoxide detector, a battery-free power circuit for powering the carbon monoxide detector and a control module. The control module is configured to stop an internal combustion engine of the motor vehicle when a concentration of carbon monoxide detected by the carbon monoxide detector over a set period of time exceeds a predetermined level.

The battery-free power circuit of the carbon monoxide detection system may include an alternator driven by the internal combustion engine. Further, the carbon monoxide detector may be positioned within a passenger compartment of the motor vehicle.

In accordance with an additional aspect, a motor vehicle may be provided wherein that motor vehicle is equipped with the carbon monoxide detection system.

In accordance with yet another aspect, a method of detecting carbon monoxide in a motor vehicle is provided. That method may be described as comprising the steps of: (1) powering a carbon monoxide detector via a battery-free circuit, (b) detecting carbon monoxide in a passenger compartment of a motor vehicle by means of the carbon monoxide detector and (c) stopping an internal combustion engine of the motor vehicle by means of a control module. That control module is configured to stop the internal combustion engine when a concentration of carbon monoxide detector over a period of time exceeds a predetermined level.

The method may further include the step of powering the carbon monoxide detector directly from an alternator of the motor vehicle. Further, the method may include positioning the carbon monoxide detector in the passenger compartment of the motor vehicle where it is protected from initial motor vehicle startup fumes as well as from the elements of the external environment.

In the following description, there are shown and described several preferred embodiments of the carbon monoxide detection system. As it should be realized, the carbon monoxide detection system is capable of other, different embodiments and its several details are capable of modification in various, obvious aspects all without departing from the carbon monoxide detection system as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the carbon monoxide detection system and together with the description serve to explain certain principles thereof. In the drawing figures:

FIG. 1 is a schematic block diagram of the carbon monoxide detection system.

FIG. 2 is a schematic block diagram of a body control module or BCM.

FIG. 3 is a schematic block diagram of a motor vehicle equipped with the carbon monoxide detection system illustrated in FIG. 1.

Reference will now be made in detail to the present preferred embodiments of the carbon monoxide detection system, examples of which are illustrated in the accompanying drawing figures.

### DETAILED DESCRIPTION

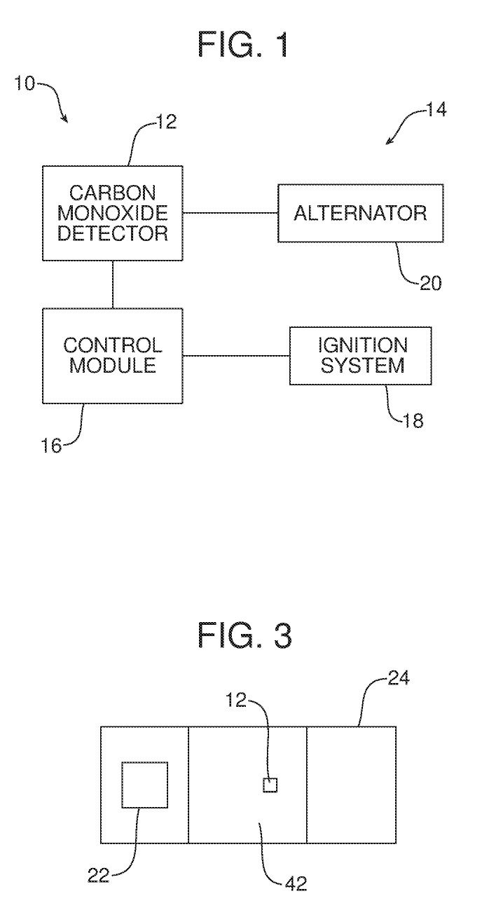

Reference is now made to FIG. 1 illustrating the carbon monoxide detection system. That carbon monoxide detection system 10 includes a carbon monoxide detector 12, a battery-free power circuit, generally designated by reference numeral 14, for powering the carbon monoxide detector and a control module 16 that is connected to the ignition system 18 of the motor vehicle.

The carbon monoxide detector 12 is a device that detects the concentration of carbon monoxide gas in the environment in order to prevent carbon monoxide poisoning. Such a detector 12 is critically important as carbon monoxide gas is not characterized by an easily recognized odor which would otherwise alert individuals to the danger. Typically, the carbon monoxide detector 12 monitors carbon monoxide as a concentration—time function so as to reduce or prevent false alarms. Types of sensors utilized for carbon monoxide detection in a carbon monoxide detector 12 include but are not limited to biomimetic, electrochemical and semiconductor.

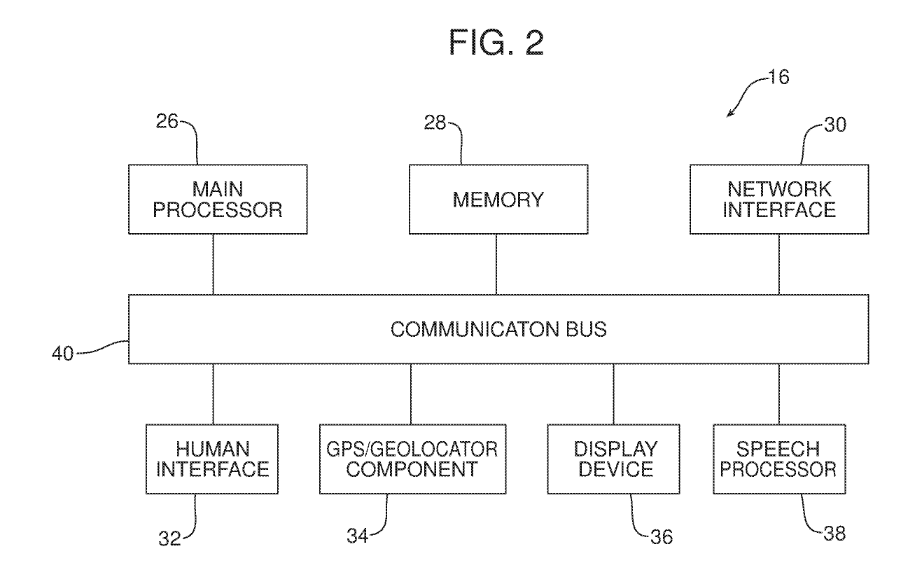

In the embodiment illustrated in FIGS. 1 and 2, the battery-free power circuit 14 comprises an alternator 20 connected to the power inputs of the carbon monoxide detector 12. Since carbon monoxide is only produced when the internal combustion engine 22 of the motor vehicle 24 is running, there is no reason to include a battery in the power circuit for the carbon monoxide detector. This arrangement provides a number of benefits. Since the detector 12 is only operated when the motor vehicle is running and not at other times, the detector should function properly over a longer service life. Further, the detector 12 does not draw down on the battery when the motor vehicle ignition is switched off. This conserves battery life and allows the stored energy in the battery to be used for other purposes.

The control module 16 may comprise a computing device, such as a dedicated microprocessor or electronic control unit (ECU) operating in accordance with instructions from appropriate control software. Such a device may have one or more processors, one or more memories, and one or more network interfaces that all communicate with each other over a communication bus. In one possible embodiment, the control module 16 may comprise a body control module or BCM.

As illustrated in FIG. 2, the BCM 16 may comprise a computing device having one or more processors 26, one or more memories 28, one or more network interfaces 30, a human interface 32, a GPS/geolocator component 34, a display device such as a multi-function display with touchscreen capability 36 and a speech processor 38 that all communicate with each other over a communication bus 40. The BCM 16 may perform a number of interior body electrically based functions including, for example, interior locking, remote key entry, interior lighting, exterior lighting, windshield wiper control and the like. In some embodiments, the BCM 16 may also function to control entertainment functions (e.g. radio, CD player and communications such as telephone and Internet communications over a wireless network). In some embodiments, the BCM 16 is connected by a communication bus (not shown) to other control modules that provide one or more of these additional functions.

Reference is now made to FIG. 3 which illustrates a motor vehicle 24 including a passenger compartment 42. The carbon monoxide detector 12 of the carbon monoxide detection system 10 is mounted within the passenger compartment 42 of the motor vehicle. In contrast, the internal combustion engine 22 is mounted to the motor vehicle outside of the passenger compartment 42.

Whenever the internal combustion engine 22 of the motor vehicle 24 is in operation, the internal combustion engine drives the alternator 20 producing an electric current that charges the battery (not shown) of the motor vehicle and powers other devices which, in this case, includes the carbon monoxide detector 12. Thus, the carbon monoxide detector 12 constantly monitors the level of carbon monoxide within the passenger compartment 42 of the motor vehicle 24 whenever the internal combustion engine 22 is operating.

In the event the internal combustion engine 22 of the motor vehicle is maintained in operation in a confined space such as the garage when the door has been closed, carbon monoxide concentrations in the local environment may rise. As should be appreciated, the carbon monoxide detector 12 provides data to the control module 16 respecting the concentration of carbon monoxide gas in the environment over time. Should those levels rise to a concentration over time that meets or exceeds a predetermined safe or threshold level programmed into the control module 16, the control module is configured to send a control signal to the ignition system 18 of the motor vehicle commanding the interruption of operation of the internal combustion engine 22 thereby ceasing further production of carbon monoxide and ensuring the safety of individuals not only in the passenger compartment but also the garage and, where the garage is connected to the home, within the interior parts of the home into which the fumes may infiltrate.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A carbon monoxide detection system for a motor vehicle, comprising:
a carbon monoxide detector;
a battery-free power circuit powering said carbon monoxide detector; and
a control module configured to stop an internal combustion engine of said motor vehicle when a concentration of carbon monoxide detected by said carbon monoxide detector over a set period of time exceeds a predetermined level.

2. The carbon monoxide detection system of claim 1, wherein said battery-free power circuit includes an alternator driven by said internal combustion engine.

3. The carbon monoxide detection system of claim 2, wherein said carbon monoxide detector is positioned within a passenger compartment of said motor vehicle.

4. The carbon monoxide detection system of claim 3, wherein said control module is a body control module for said motor vehicle.

5. The carbon monoxide detection system of claim 1, wherein said carbon monoxide detector is positioned within a passenger compartment of said motor vehicle.

6. The carbon monoxide detection system of claim 1, wherein said control module is a body control module for said motor vehicle.

7. A motor vehicle equipped with the carbon monoxide detection system of claim 1.

8. A motor vehicle equipped with the carbon monoxide detection system of claim 2.

9. A motor vehicle equipped with the carbon monoxide detection system of claim 3.

10. A motor vehicle equipped with the carbon monoxide detection system of claim 4.

11. A motor vehicle equipped with the carbon monoxide detection system of claim 5.

12. A motor vehicle equipped with the carbon monoxide detection system of claim 6.

13. A method of detecting carbon monoxide in a motor vehicle, comprising:
powering a carbon monoxide detector via a battery-free circuit;
detecting carbon monoxide in a passenger compartment of said motor vehicle by said carbon monoxide detector; and
stopping an internal combustion engine of said motor vehicle by means of a control module configured to stop said internal combustion engine when a concentration of carbon monoxide detected over a set period of time exceeds a predetermined level.

14. The method of claim 13, including powering said carbon monoxide detector directly from an alternator of said motor vehicle.

15. The method of claim 14, including positioning said carbon monoxide detector in said passenger compartment of said motor vehicle.
